(19) United States
(12) Patent Application Publication
(10) Pub. No.: US 2019/0012686 A1
(43) Pub. Date: Jan. 10, 2019

(54) SYSTEM AND METHOD FOR OPTIMIZATION USING AUTONOMOUS VEHICLE

(71) Applicant: PANASONIC INTELLECTUAL PROPERTY MANAGEMENT CO., LTD., Osaka (JP)

(72) Inventors: Matthew John LAWRENSON, Lausanne (CH); Julian Charles NOLAN, Lausanne (CH)

(73) Assignee: PANASONIC INTELLECTUAL PROPERTY MANAGEMENT CO., LTD., Osaka (JP)

(21) Appl. No.: 16/022,083

(22) Filed: Jun. 28, 2018

Related U.S. Application Data
(60) Provisional application No. 62/528,770, filed on Jul. 5, 2017.

(51) Int. Cl. G06Q 30/02; G06Q 10/08; G01C 21/30; G01C 21/34; G07C 5/00; G06K 9/00; G05D 1/00; G05D 1/02

(52) U.S. Cl. CPC G06Q 30/0205; G06Q 10/087; G01C 21/30; G01C 21/34; G05D 2201/0213; G06K 9/00791; G05D 1/0088; G05D 1/0223; G07C 5/008

(57) ABSTRACT

A method for optimizing operations using an autonomous vehicle is provided. The method includes receiving input data, receiving sensor data collected by an autonomous vehicle, and identifying an instance where a portion of the sensor data and a portion of the input data are correlated. The method further includes identifying the portion of the sensor data included in the instance where the portion of the sensor data and the portion of the input data are correlated as a trigger signal, and modifying a process of a target retailer based on the trigger signal.

### CROSS-REFERENCE TO RELATED APPLICATION(S)

The present application claims the benefit of U.S. Provisional Patent Application No. 62/528,770 filed on Jul. 5, 2017. The entire disclosure of the above-identified application, including the specifications, drawings and/or claims, is incorporated herein by reference in its entirety.

### BACKGROUND

### 1. Field of the Disclosure

The present disclosure relates to optimizing operations at a retailer. More particularly, the present disclosure relates to correlating sensor data collected by an autonomous vehicle and activity at a retailer, and optimizing operations at the retailer using the correlation.

### 2. Background Information

A. Autonomous Vehicles

An autonomous vehicle (AVs) is a vehicle capable of sensing its location, details of its surrounding environment and navigating along a route without needing a human driver.

Autonomous Vehicles need a significant amount of data relating to their local environment in order to know where they are located. One common form of data is video data, and it is suggested that cameras mounted on autonomous vehicles will be collecting Gb/s of data as the vehicles are operated.

Autonomous vehicles also contain many other sensors, which may be used to collect, for example, 3D maps of objects and their surroundings, meteorological data or acoustic data. This data may have other uses, including identification of inputs that can be used to determine how sales of various objects may be affected.

B. Machine Learning

Machine Learning is a form of data processing that is able to find patterns within data. It is related to data mining, where again small patterns are uncovered through the examination of large amounts of data.

C. Retail Optimization

Retail is a significant market, an estimated two thirds of US gross domestic product comes from retail consumption. In this regard, retailers may seek to optimize processes both to make the delivery of goods more efficient, and also to increase the amount of goods sold.

I. Retail Use of Big Data

One tool use by retailers is the analysis of the significant amount of data they collect during the retail process. ‘Big data’ is used in retail, for example to (i) optimize which stock is sold, (ii) increase the effectiveness of marketing campaigns and (iii) help manage shop/store operations.

Retailers can collect data at the point of each transaction, and where additional information is known about the customer. For example, by using loyalty programs, then purchases can be correlated to customer types. Even without knowing the specific customer purchases sales can be correlated to data, such as location, weather, and events.

As such analysis is data-driven, in that the analysis favors larger retailers that have more sales, and also more capability to install infrastructure that is able to collect data.

II. Advertisement and in-Store Displays

Other tools used by retails to increase sales include advertisements, and in store promotions.

Advertisements, and the position of advertisements may use techniques such as ‘attention theory’ which suggests that small sensory signals, that may not form a meaningful signal when they are first received may contribute to a later decision. For example, seeing a certain image may be ‘unattended’ at the time, but may contribute to a later decision that is related to that image.

### BRIEF DESCRIPTION OF THE DRAWINGS

FIG. 1 shows an exemplary general computer system that is configured to perform optimization, according to an aspect of the present disclosure;

FIG. 2 shows an exemplary system for performing optimization, according to an aspect of the present disclosure;

FIG. 3 shows an exemplary autonomous vehicle, according to an aspect of the present disclosure;

FIG. 4 shows an exemplary retail systems unit, according to an aspect of the present disclosure;

FIG. 5 shows an exemplary analysis unit, according to an aspect of the present disclosure;

FIG. 6 shows an exemplary process for performing optimization, according to an aspect of the present disclosure;

FIG. 7 shows an exemplary process for generating advertising materials, according to an aspect of the present disclosure;

FIG. 8 shows an exemplary optimization process for a retailer, according to an aspect of the present disclosure; and

FIG. 9 shows an exemplary process for comparing of data of multiple retailers, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

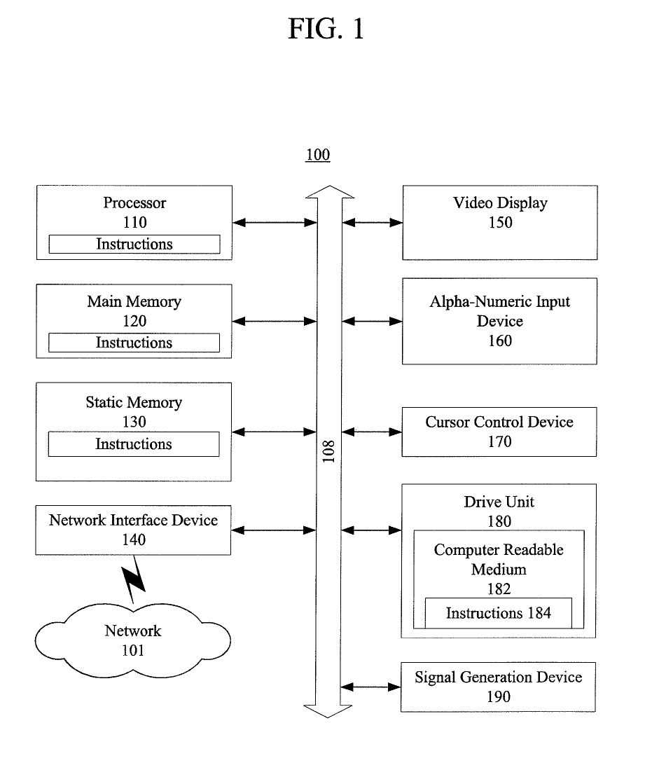

FIG. 1 shows an exemplary general computer system that is configured to perform optimization, according to an aspect of the present disclosure.

A computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smart phone, a set-top box (STB), a personal digital assistant (PDA), a communications device, a control system, a web appliance, a network router, switch or bridge, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

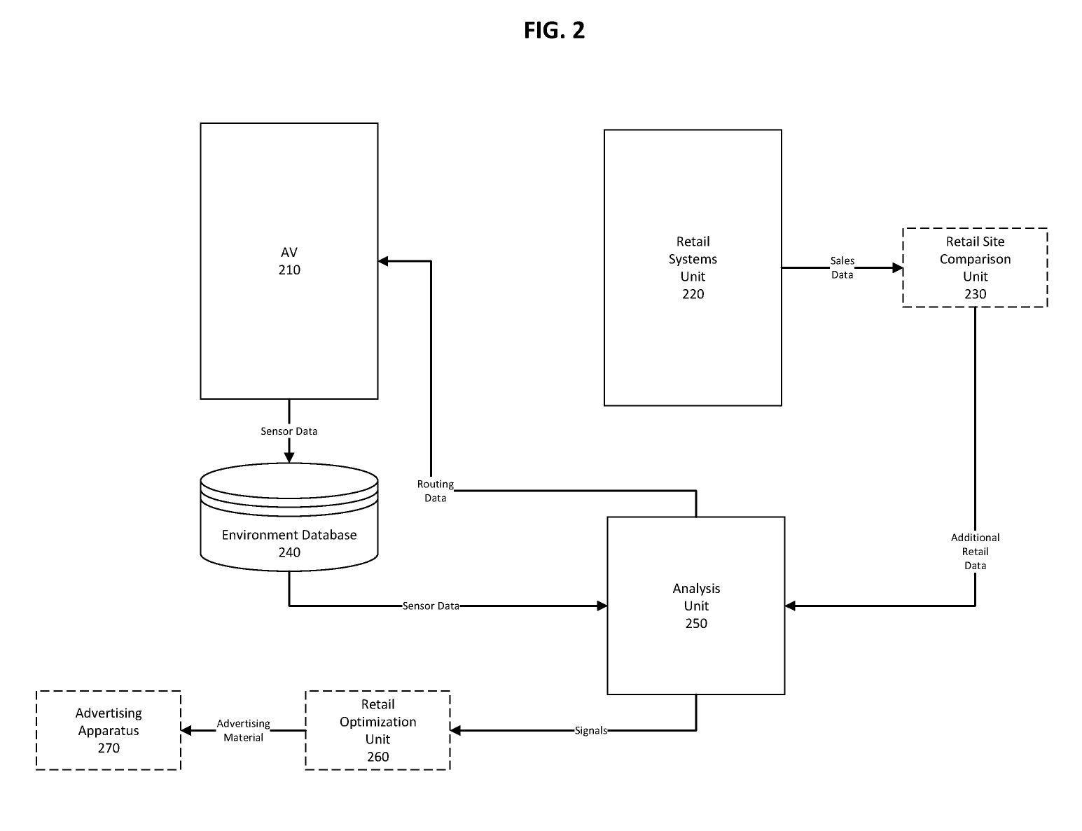

FIG. 2 shows an exemplary system for performing optimization, according to an aspect of the present disclosure.

As illustrated in FIG. 2, a system for optimizing local sales using an autonomous vehicle includes an autonomous vehicle (AV) 210, a retail system unit 220, a retail site comparison unit 230, an environment database 240, an analysis unit 250, a retail optimization unit 260, and an advertising apparatus 270. At least one of the retail system unit 220, the retail site comparison unit 230, the environment database 240 the analysis unit 250, retail optimization unit 260, and advertising apparatus 270 may be implemented as a computer, server, an integrated circuit or a combination of processors and memory.

Retailers may wish to optimize various processes with respect to at least current sales possibilities and consumer motivations. For example, by knowing who is in a vicinity of a retail outlet, the retailer may stock items that they are likely to buy. In an example, if a retailer obtains information that its location is surrounded by extreme sport parks, the retailer may stock up on energy drinks and run promotions of the energy drinks. At least because shelf space at a retailer may be limited, knowing what items to stock up will allow the retailer to stock up more efficiently. In another example, by knowing of changes to environment (e.g., weather, events, road conditions, groups of people and the like) surrounding the retailer, the retailer may be aware of changing motivations of consumers. In an example, if the retailer is aware that a storm is approaching the retailer, the retailer may stock up on umbrellas.

By knowing surrounding environment information, retailers may be able to both (i) more efficiently sell their merchandize, and (ii) increase the amount of products sold. Hence, retailers may wish to collect and use measured data in order to determine correlations. Some of the data may be subtle and may not have an obvious link to the sale process or products being. Further, some of the data may be complex (i.e., a combination of many subtle signals), when combined, provide an insight that can be used by the retailer.

However, some of these data required for calculating these optimization may be measured outside of the retailer facilities, such as surrounding neighborhoods, buildings, people present, and the like (i.e., areas where the respective retailer has sparse or no sensing capability). Such data may be able to be collected by one or more autonomous vehicles.

The autonomous vehicle 210 may include multiple sensors of varying type. The sensors of the autonomous vehicle 210 may gather sensor data relating to area surrounding the AV, such as roads, buildings, nearby objects and the like. For example, sensor data may include, without limitation, image data, audio data, three-dimensional (3D) object data, motion data, and meteorological data (e.g., temperature, precipitation, moisture and etc.). The sensors of the autonomous vehicle 210 may include, without limitation, a camera, a microphone, a LIDAR, a Radar, and one or more weather sensors (e.g., temperature sensor, humidity sensor, wetness sensor and etc.).

Further, the autonomous vehicle 210 may also include a routing unit. The routing unit may be able to modify the route taken by the AV. In an example, the routing unit may include a routing determination unit and an arrival time estimation unit. The routing determination unit may include and/or execute a routing determination algorithm, and the arrival time estimate unit may include and/or execute an arrival time estimation algorithm. The routing determination unit may generate or create a route for the AV's journey or destination. The arrival estimation unit may be able to estimate the AV's arrival time (ETA) at the terminal point of the route.

According to an aspect of the present disclosure, one or both of the routing determination unit and the arrival estimation unit may use external data sources or database servers that provide additional information for determining the best route or more accurately judge the estimated time of arrival of the AV at a chose destination.

The other data sources includes, without limitation, databases containing traffic data, data sources that are able to estimate a number of autonomous vehicles compared to human-driven vehicles on the determined route to the selected restaurant, and databases storing current and predicted meteorological data. Further, the other data sources may be one or more external databases that may connected to the autonomous vehicle 210 via a network.

The retail systems unit 220 may be a computer or a server that may be used by retailers for collecting sales data. The retail systems unit 220 may include a retail data collection unit for collecting retail data (e.g., sales data) that provides information regarding specific sales of goods or services (items). In an example, the retail data collection unit may include, without limitation, registers, near field communication (NFC) terminals, credit card terminals, self-service kiosks, and smartphone enabled payment (e.g., Apple Pay). The retail data may include, without limitation, sold items (e.g., description of item sold, price, applicable sales promotion, applicable coupons, and the like), time and/or day at which the items were sold, location or department at which the items were sold. The retail systems unit 220 may also include a sales database to store sales data.

The retail site comparison unit 230 may receive sales data from multiple retail system units 220, and execute a retail site comparison algorithm to identify significant similarities between the retail system units 220. In an example, the retail site comparison unit 230 may determine whether sales data from one retailer is similar, within a reference threshold (e.g., 90% similar) to sales data from other retailer(s). Such comparisons for determination may be performed over and over for determining correlation between the sensor data and the sales data to provide for more reliable data. If the sales data are determined to be similar between multiple retailers, the sales data may be combined or grouped to provide for a larger or more reliable dataset.

The environment database 240 may receive sensor data from the autonomous vehicle 210, and store the received sensor data. In an example, sensor data of only the designated autonomous vehicles may be collected and/or stored. For example, sensor data of autonomous vehicle traveling within a two mile radius may be collected for storage. Further, the stored sensor data may be stored for predetermined period of time for select data. More specifically, sensor data corresponding to a sales activity may be stored for the predetermined period of time, whereas sensor data identified as being irrelevant may be purged after certain duration. The stored sensor data may be retrieved by the analysis unit 250.

The analysis unit 250 may be implemented as a computer, server or an integrated circuit. The analysis unit 250 may receive input from the environment database 240 and retail site comparison unit 230.

The analysis unit 250 may receive or extract environment data (e.g., sensor data collected by passing by autonomous vehicles) and sales data as inputs. In view of these inputted data, the analysis unit may identify instances where environment data and the sales data are correlated. For example, the analysis unit may identify that during snowing days, sales of hot chocolate of brand X increases more than 300%. These instances of correspondence may be saved as a trigger signal. Further, the trigger signal is transmitted to a retail optimization unit 260.

In an example, a trigger signal may include a single piece of environmental data or a set of environmental data (e.g., multiple pieces of sensor data is associated with sales activity of a particular item). Similarly, a trigger signal may consider sales of a certain item or a set of sales data. In an example, multiple types of sensor data are used (e.g., a certain object is recognized while at the same time certain meteorological data is within a certain tolerance. Further, the sensor data may be correlated to a change in sales of a class of a particular product, for example, soft drinks.

The analysis unit 250 may take environment data and sales data as inputs and identify one or more trigger signals. For identifying the trigger signals, various thresholds for strength of correlation may be used. For example, a first threshold may be used whereby a correlation may be achieved, such that a user may be confident that when a certain set of events are sensed, sales of corresponding item(s) have a strong likelihood of increasing. Such events may be deemed as valid signals or valid trigger signals.

If some correlation is determined to exist but has not achieved a requisite threshold to qualify as a valid signal, then additional data may be gathered to supplement the correlation. Such signals indicating some correlation but less than the requisite threshold may be referred to as intermediate signals. For such signals, the algorithm optimization unit may determine a route for an autonomous vehicle to gather additional sensor data to supplement the correlation for the intermediate signals. If the supplementation of sensor data strengthens the correction to the requisite threshold, the respective intermediate signal may be identified as a valid trigger signal.

In an example, in order to validate trigger signals, the signal extraction algorithm may access stored data including values indicating a desired strength of correlations. Such data may be manually derived using an assessment of historic data.

Further, the analysis unit 250 may create a routing change request for one or more autonomous vehicles for collection of additional sensor data for supplementing strength of the intermediate trigger signals. In an example, the routing change request may be described as a set of routing data and include, without limitation, a route to be taken by an autonomous vehicle, a description of sensor data to be collected by the autonomous vehicle at various points of the route.

The analysis unit 250 may store the trigger signals in a signal database. The analysis unit 250 may additionally store intermediate trigger signals in the signal database or in a separate database. The signal database may additionally store associated data for the stored trigger signals, valid or intermediate. The associated data may include, without limitation, data collected at the same time, or within a reference period from the respective time, as the data of the trigger signal but that was not correlated as part of the trigger signal.

The retail optimization unit 260 may take the trigger signals as an input and optimize a process, such as staffing process, used by a retailer. For example, the retail optimization unit 260 may control current utilization of staff within the retailer. More specifically, the utilization of staff may specify which staff members are operating the registers, maintaining display areas of the retailer, are on break and the like.

Further, the retail optimization unit 260 may modify a profile of staff and/or activities to best match forthcoming increase in sales. For example, organization of a display area within the retailer. Such process may combine a dynamic re-assignment of tasks for the employees. In an example, if a sharp increase in sales activities is expected, then more staff members may be assigned to man the registers. Also, display of merchandize may be modified. For example, specific display arrangement or placement of items.

The advertising apparatus 270 may provide advertising material to potential consumers or public within a reference distance from the retailer, or at specific locations or events. The advertising apparatus 270 includes an LCD screen and a loudspeaker. Further, in an example, the advertising apparatus 270 may be equipped on an autonomous vehicle, which may be directed to travel along a specified route near a retailer or towards a specific area having congregation of potential consumers (e.g., bus stop).

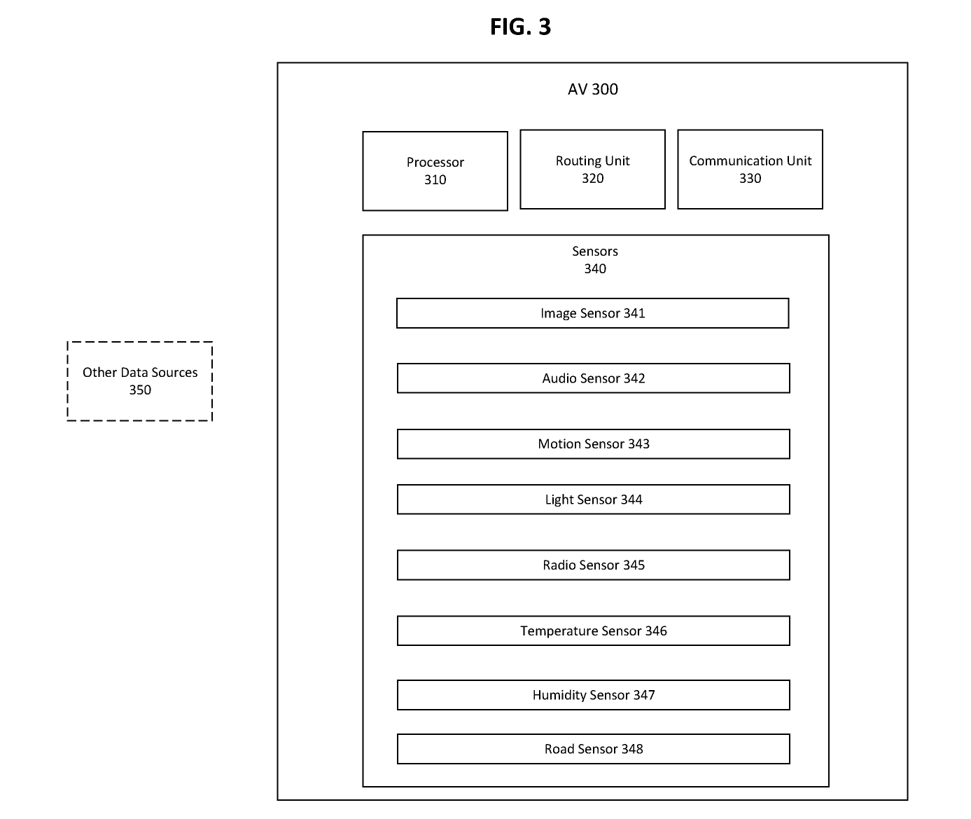

FIG. 3 shows exemplary autonomous vehicle, according to an aspect of the present disclosure.

For an autonomous vehicle (AV) to operate properly, the autonomous vehicle relies on very detailed maps, such as high-definition (HD) maps, and various sensor data collected and analysed in view of the HD maps. The HD maps may collect various data using various autonomous vehicle sensors with respect to its surrounding environment to identify its location and to perform operation of the autonomous vehicle. More specifically, the autonomous vehicle sensors may collect data of surrounding static physical environment, such as nearby buildings, road signs, mile markers and the like, for determining its respective location. Further, autonomous vehicle sensors may also collect data of nearby moving objects, such as other vehicles, pedestrians, events and the like. Also, the autonomous vehicle sensors may also collect various meteorological data, such as temperature, humidity, precipitation, and the like, as well as environmental information, such as road conditions.

Autonomous vehicle 300 includes a processor 310, a routing unit 320, a communication unit 330, and sensors 340. In an example, the processor 310 may control or execute other units to the autonomous vehicle 300 to produce an output. However, aspects of the disclosure are not limited thereto, such that some of the above noted units may not be included in the autonomous vehicle or that autonomous vehicle may include additional units. One or more of the above noted units may be implemented as circuits. Further, one or more of the above noted units may be included in a computer.

The processor 310 may execute one or more operations of units of the autonomous vehicle 300. For example, the processor 310 may execute an algorithm stored in a unit of the autonomous vehicle 300 to produce an output.

The routing unit 320 may include a routing determination algorithm, which when executed, may generate or create a route for the autonomous vehicle's journey or destination. In an example, the routing unit 320 may include a route which includes a portion that travels through a predetermined range of the retailer. Alternatively, the autonomous vehicle's route may be configured to travel through a specific range or area near a retailer for capturing of specific sensor data. For example, the routing unit 320 may request a route for collecting sensor data requiring specific camera angles, field of view, and the like. The route may additionally specify speed of travel for collecting the sensor data. In addition, the routing unit 320 may specify a route in consideration of other autonomous vehicles in the area. For example, the routing unit 320 may specify one autonomous vehicle to travel around a surrounding block of the retailer, or may specify to travel only a portion of the surrounding block.

The communication unit 330 may perform communication with various servers or units of the sales optimization system. For example, the communication unit 330 may receive routing information from an analysis unit, or transmit sensor data to an environment database. Further, the communication unit 330 may communicate with other communication units of other autonomous vehicles. In an example, a group of autonomous vehicles may work together to travel around a surrounding area of the retailer, where each of the group of autonomous vehicles will travel a select portion of the surround area for division of labor.

By performing communication with other autonomous vehicles, autonomous vehicles as a group may provide a blanket coverage. For example, if an event is predicted then a first autonomous vehicle may provide a likely timing to a second autonomous vehicle in order for the second autonomous vehicle to have the best location/orientation and/or timing to capture the respective event.

The autonomous vehicle 300 includes a plurality of sensors 340. The sensors 340 include an image sensor 341, an audio sensor 342, a motion sensor 343, a light sensor 344, a radio sensor 345, a temperature sensor 346, a humidity sensor 348, and a road sensor 348. Although a specific set of sensors are illustrated in FIG. 3, aspects of the present disclosure are not limited thereto, such that an autonomous vehicle may include less or more sensors than those illustrated in FIG. 3.

In an example, the image sensor 341 may include one or more cameras for capturing images. The audio sensor 342 may include one or more microphones for capturing audio data. The motion sensor 343 may include one or more infrared sensors and the like for capturing movement of objects or people. The light sensor 344 may include one or more light sensors that detect level of light, or captures a reflection of light for detecting objects or people and corresponding distances. The radio sensor 342 may capture radio signals or reflection thereof for detecting objects or people and corresponding distances. The temperature sensor 342 may include a thermometer, heat sensor or the like for detecting a temperature of surrounding environment. The humidity sensor 348 may detect a humidity level of surrounding environment. The road sensor 348 may detect a condition (e.g., wet, icy, slippery, or the like) of a road on which the autonomous vehicle may be traveling on or nearby sidewalks.

In addition to capturing of sensor data via the sensors 340, the autonomous vehicle may also obtain additional information from other data sources 350. The other data sources 350 may be an external server that may store environment related data. For example, the other data sources 350 may include, without limitation, databases containing traffic data, data sources that are able to estimate a number of autonomous vehicles compared to human-driven vehicles on the determined route to the selected restaurant, and databases storing current and predicted meteorological data. Further, the other data sources 350 may be one or more external databases that may connected to the autonomous vehicle 300 via a network.

The sensors 340 may gather sensor data while traveling along a route and transmit the gathered sensor data to an environment database for storage.

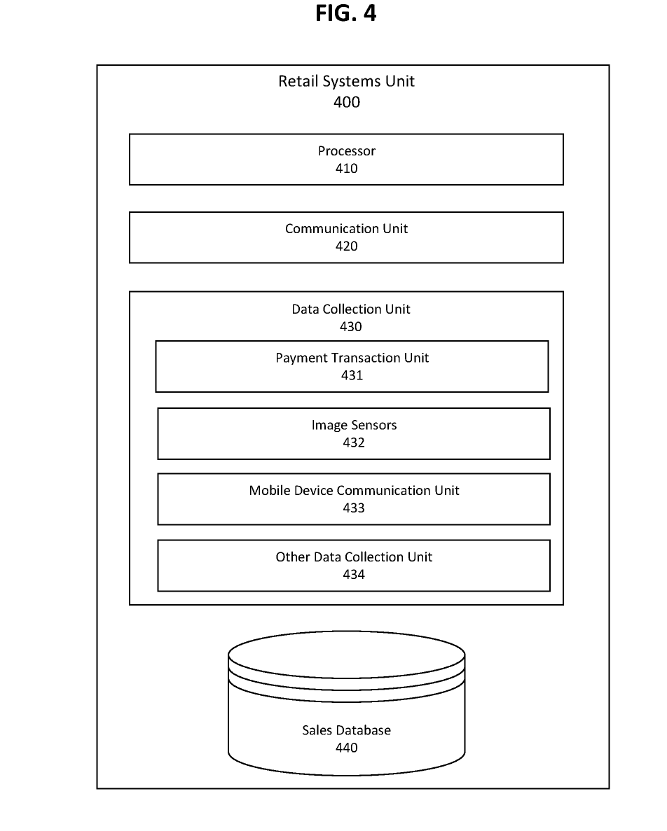

FIG. 4 shows an exemplary retail systems unit, according to an aspect of the present disclosure.

A retail systems unit 400 includes a processor 410, a communication unit 420, a data collection unit 430, and a sales database 440. In an example, the processor 410 may control or execute other units to the retail systems unit 400 to produce an output. However, aspects of the disclosure are not limited thereto, such that a retail systems unit may include less than or more than the above noted units. Further, one or more of the above noted units may be implemented as circuits. Further, one or more of the above noted units may be included in a computer.

The processor 410 may execute one or more operations of units of the retail systems unit 400. For example, the processor 410 may execute an algorithm stored in a unit of the retail systems unit 400 to produce an output.

The communication unit 410 may communicate, via a network, with various components of a sales optimization system. For example, the communication unit 410 may transmit sales data collected by the retail systems unit 400 to a retail site comparison unit for aggregation of sales data. Alternatively, the communication unit 410 may transmit the sales data to an analysis unit for determination of a correlation between sensor data collected by an autonomous vehicle and the sales data collected by the retail systems unit 400.

The data collection unit 430 includes a payment transaction unit 431, image sensors 432, a mobile device communication unit 433, other data collection unit 434, and a sales database 440. Although a specific set of data collection units are illustrated in FIG. 4, aspects of the present disclosure are not limited thereto, such that a data collection unit may include less or more than the data collection units illustrated in FIG. 4.

In an example, payment transaction unit 431 may include self-service kiosks, cash registers or the like. The image sensors 432 may include various cameras that may be located within a retailer facility. Mobile device communication unit 433 may include store provided scanners or mobile devices of consumers that may be used to purchase items at the retailer facility. In an example, data from the mobile devices may be collected when the mobile device connects to a store provided Wi-Fi or by utilizing an application of the retailer. Further, data from the mobile devices may be collected when mobile payment application is used (e.g., Apple Pay®). Other data collection unit 434 may include microphones that may be located throughout the retailer facility, or other device that may be used to collect sales tendencies or activities by a consumer at the retailer facility.

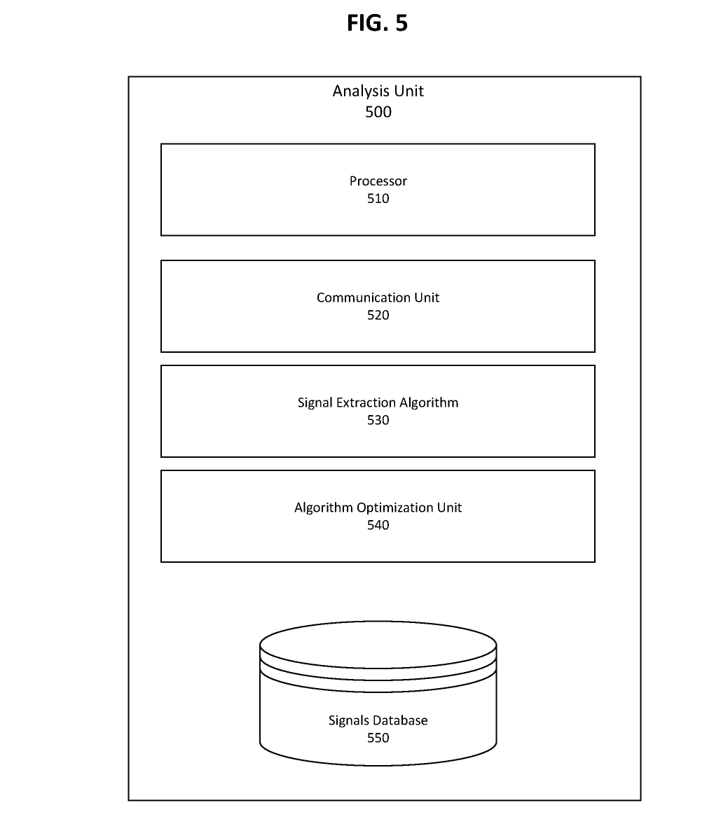

FIG. 5 shows an exemplary analysis unit, according to an aspect of the present disclosure.

The analysis unit 500 includes a processor 510, a communication unit 520, a signal extraction algorithm 530, an algorithm optimization unit 540, and signals database 550. However, aspects of the disclosure are not limited thereto, such that some of the above noted units may not be included in the analysis unit 500 or that the analysis unit 500 may include additional units. One or more of the above noted units may be implemented as circuits. Further, one or more of the above noted units may be included in a computer.

The processor 510 may control or execute one or more units of the analysis unit 500 to produce an output.

The communication unit 520 may include a transmitter and a receiver to transmit and receive signals from other units included in the system illustrated in FIG. 2. For example, the communication unit 520 may communicate with an environment database to extract or receive sensor data collected by an autonomous vehicle, or may communicate with the autonomous vehicle to transmit routing data or a route change request for capturing additional sensor data and the lie. Further, the analysis unit may receive sales data from a retail systems unit of a target retailer directly or through an aggregate server. More specifically, the analysis unit may receive sales data and/or additional retail data from a retail site comparison unit, which may include sales data of other retailers as well as the target retailer. Further, once trigger signals are identified by the analysis unit 500, the analysis unit 500 may transmit the trigger signals to a retail optimization unit for application of the trigger signals.

The signal extraction algorithm 530 may be executed by the processor 510 to extract environment data or sensor data collected by the autonomous vehicle and sales data of one or more retailers. The Extracted data may be used as inputs to identify one or more trigger signals. For identifying the trigger signals, various thresholds for strength of correlation may be used. In an example, the strength of correlation may refer to a likelihood of a corresponding activity to occur in view of a particular sensor data or a set of sensor data. The strength of correlation may refer to the strength of likelihood and/or confidence level based on amount of evidence (e.g., a number of observed sales corresponding to the detected sensor data) indicating such correlation. Further, if the strength of correlation is determined to be at or above a predetermined threshold, then the trigger signal may be determined to be a valid signal, which may be relied on by one or more retailers to adjust one or more of their processes (e.g., staffing, store layout, advertising and the like). However, if the strength of the correlation is determined to be below the predetermined threshold, the trigger signal may be determined to be an intermediate signal until the strength of correlation is increased to validate the trigger signal. Further, if the trigger signal is determined to be the intermediate signal, the analysis unit 500 may direct the trigger signal to the algorithm optimization unit 540 for further processing.

The algorithm optimization unit 540 may be able to receive data, such as intermediate trigger signal data, from the signal extraction algorithm and create a routing change request for one or more autonomous vehicles for collection of additional sensor data. In an example, the routing change request may be described as a set of routing data and include, without limitation, a route to be taken by an autonomous vehicle, a description of sensor data to be collected by the autonomous vehicle at various points of the route.

The signals database 550 may store valid trigger signals and intermediate trigger signals. The stored signals may be extracted for further processing or validation. For example, valid trigger signals may be transmitted to the retail optimization unit of a retailer for modification of its processes according to detection of sensor data corresponding to the trigger signals. Alternatively, the intermediate trigger signals may be stored until supplemental data is received to strengthen the correspondence. However, aspects of the present disclosure are not limited thereto, such that retailers may specify different threshold values to validate a trigger signal. Accordingly, some retailers may be willing to receive a trigger signal, which another retailer trigger may as being intermediate, as a valid signal for modifying its processes.

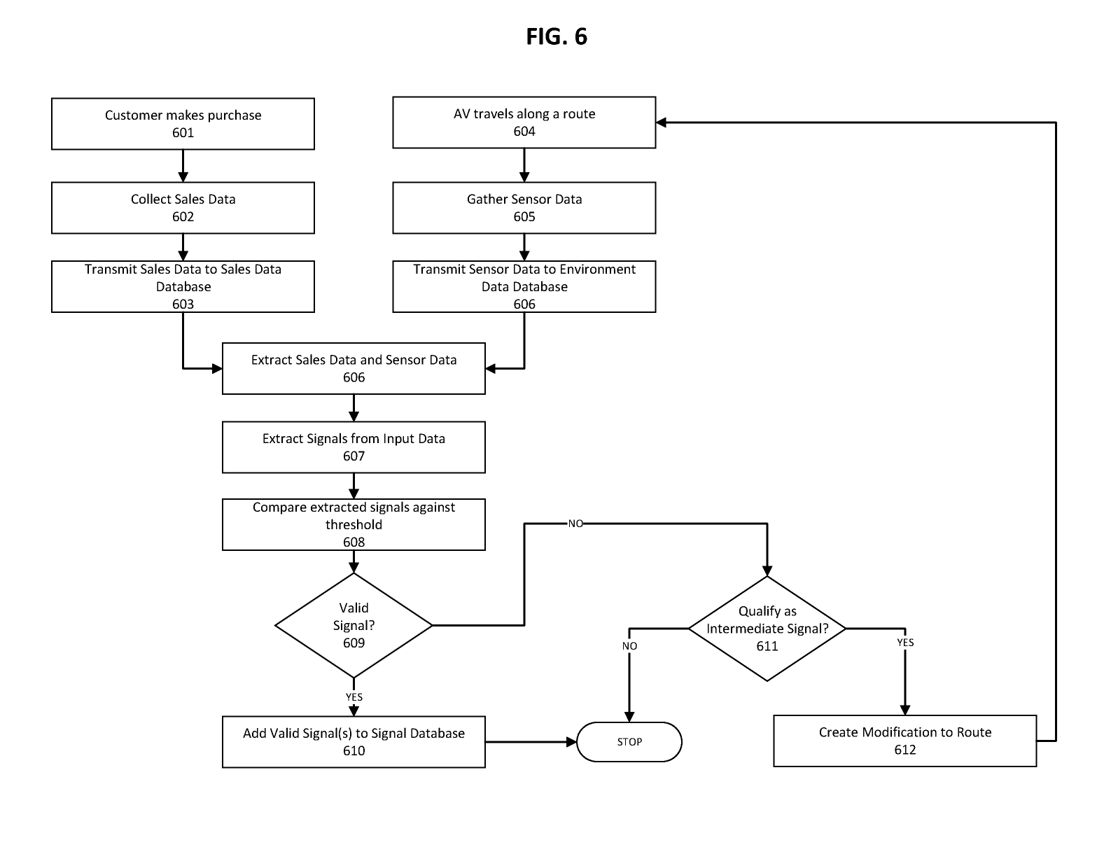

FIG. 6 shows an exemplary process performing optimization, according to an aspect of the present disclosure.

In operation 601, a customer purchases one or more items at a retailer. The items may be include goods or services that may be purchased via payment. The items may be purchased at registers, near field communication (NFC) terminals, credit card payment terminals, and smartphone enable payment.

In operation 602, once the payment transaction has been completed, sales data related to the sales transaction is collected. The sales data may include, without limitation, sold items (e.g., description of item sold, price, applicable sales promotion, applicable coupons, and the like), time and/or day at which the items were sold, location or department at which the items were sold.

In operation 603, the generated sales data is transmitted to the sales database for storage. In an example, the sales data may be stored for a predetermined period of time before being purged.

Further, contemporaneously with the sale transaction, one or more autonomous vehicles travel along a predetermined route in operation 604. In an example, the predetermined route may be specified by an operator of the autonomous vehicle or may be specified by a retailer.

In operation 605, the one or more autonomous vehicles collect, using various sensors, relevant sensor data during the travel along the predetermined route. For example, sensor data may include, without limitation, image data captured by a camera, audio data captured by a microphone, a three-dimensional (3D) object data captured by a LIDAR, motion data captured by a RADAR or LIDAR, and meteorological data (e.g., temperature, precipitation, moisture, and the like).

In operation 606, the autonomous vehicle transmits the sensor data is transmitted to the environment database for storage. In an example, the sensor data may be stored for a predetermined period of time before being purged.

In operation 607, the sales data and the sensor data are extracted for analysis. In an example, a signal extraction algorithm executed at an analysis unit may cause the analysis unit to extract sensor data from the environment database and extract associated sales data from the sales database. The sales data and the sensor data may be extracted for a predetermined time range or time ranges. For example, the sales data and the sensor data collected during a concert that was performed during hours of 6 PM to 8 PM on a particular date. In another example, sales data that is collected predetermined period after the detection of the sensor data may be collected. For example, if the sensor data detects a rain storm at 12 PM, sales data following the detection of the rain storm may be collected (e.g., 15 minutes after detection of the rain storm). Further, a first type of data may be selected and then all associated data points from a second type of data may be requested. For example, the analysis unit may choose a set of sensor data, and then request all sales data from the same time period the sensor data to be gathered. Alternatively, one item from the sales data may be selected, and all sensor data present when the selected item was purchased may be requested.

In operation 607, a correlation between the collected sensor data and the sales data is extracted. For example, a signal extraction algorithm may be executed to extract a correlation signal from the inputted data. In an example, when a first item was purchased at a retailer, there may be an increased likelihood of a certain profile of a person being present within a vicinity of the retailer facility. In another example, detection of a first occurrence of a certain type of sensor data (e.g., a certain flower blooming), may correlate to a second item having an increase in sales. Further, in another example, higher sales of a third item may occur when high densities of people wearing sporting goods are found. Also, where the people are traveling in a southern direction, and the weather is a certain temperature, may correlate to predominant color of passing vehicles may be red.

In operation 608, the extracted signals are compared against a predetermined threshold to determine whether the extracted signal is a valid signal. In an example, the extracted signals are extracted and compared against a set of thresholds to see if they are considered valid (i.e., the correlation is determined strong enough to be reliably used by the retailer). In an example, the thresholds may be specific to an item or retailer, and may be stored within a memory of an analysis unit or a remote database.

In operation 609, if the correlation signal is determined to be valid or of sufficient strength, then the method proceeds to operation 610. In operation 610, the valid signal is transmitted to a signal database for storage. Alternatively, if the correlation signal is determined not to be valid or of insufficient strength, the method proceeds to operation 611. In operation 611, a further determination as to whether the correlation signal qualifies as an intermediate signal is determined.

If the correlation signal does not qualify as an intermediate signal, then the method is terminated. Alternatively, if the signal qualifies as an intermediate signal, the intermediate signal is transmitted to an algorithm optimization unit for execution in operation 612. In an example, the algorithm optimization unit may assess which autonomous vehicle is likely to be able to collect additional sensor data at the location at which the intermediate signal data was collected. The autonomous vehicle may be assessed based on its respective location with respect to the retailer and/or preferences set by an owner of the autonomous vehicle (e.g., whether the owner allows a change to a route). Further, the algorithm optimization unit may determine which additional data may be required to increase the strength of the intermediate signal to validate the correlation signal.

Also, the algorithm optimization unit may determine to re-route the autonomous vehicle to pass through locations where the required additional sensor data may be collected. The modified route for re-routing the autonomous vehicle may be determined by creating a set of routing data, being data that describes the route to be taken, and sending the routing data to the autonomous vehicle. Optionally, the routing data may also include a description of the data to be collected. Further, additional instructions for the autonomous vehicle, such as its orientation, speed, and other operation settings that should be executed while the sensor data is being collected.

In operation 612, modification to the route is created to re-route an autonomous vehicle from its current route. Once the autonomous vehicle is re-routed, then the method proceeds back to operation 604.

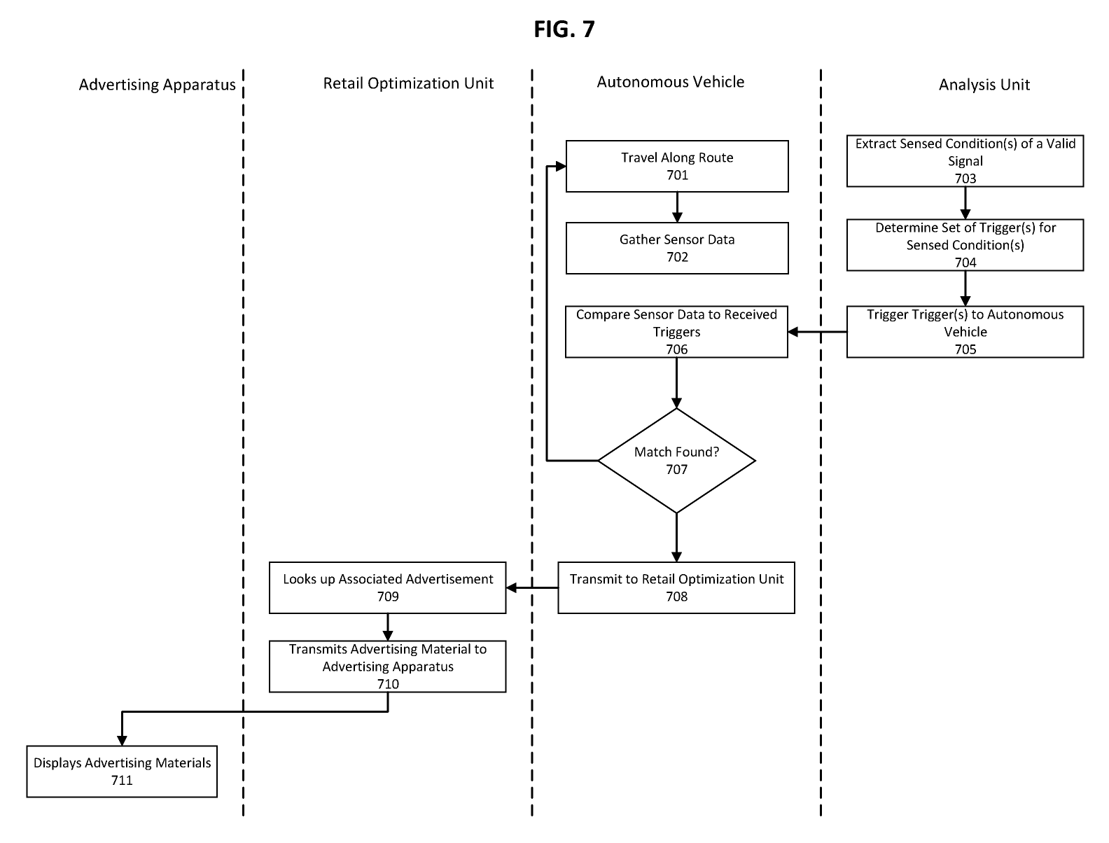

FIG. 7 shows an exemplary process for generating advertising materials, according to an aspect of the present disclosure.

In operation 701, one or more autonomous vehicles travel along a predetermined route. In an example, the predetermined route may be specified by an operator of the autonomous vehicle or may be specified by a retailer.

In operation 702, the one or more autonomous vehicles collect, using various sensors, relevant sensor data during the travel along the predetermined route. For example, sensor data may include, without limitation, image data captured by a camera, audio data captured by a microphone, a three-dimensional (3D) object data captured by a LIDAR, motion data captured by a RADAR or LIDAR, and meteorological data (e.g., temperature, precipitation, moisture, and the like).

In operation 703, the analysis unit extracts one or more sensed conditions of a valid signal, which may be stored in a signal database of the analysis unit. A valid signal may include identification of a set of sensor data, or sensed conditions. For example, co-occurrence of a certain profile of a customer passing the retailer facility in a certain direction when the weather has certain characteristics.

In operation 704, a set of triggers or sensor triggers are determined for the one or more sensed conditions extracted in operation 703. In an example, a sensor trigger may be a value of sensor data or a trend in sensor data. The value of sensor data may be threshold value that has to be reached to validate a correspondence signal. Further, trends in the sensor data may indicate a possibility that a valid signal may occur in the future.

In operation 705, the analysis unit transmits the determined set of triggers to the autonomous vehicle.

In operation 706, the autonomous vehicle receives the set of triggers from the analysis unit and compares the sensor data collected in operation 702 to the received set of triggers.

In operation 707, a determination of whether the sensor data collected in operation 702 matches with the received set of triggers is made. If the autonomous vehicle determines that the sensor data matches with the received triggers, then the matched trigger is transmitted to a retail optimization unit in operation 708. If the autonomous vehicle determines that the sensor data does not match with the received triggers, then the autonomous vehicle continues to travel along a route for collection of additional sensor data in operations 701 and 702.

In operation 709, the retail optimization unit receives the matched trigger, and looks up an advertisement associated with the trigger. In an example, the retail optimization unit may identify, from a lookup table, an advertisement that promotes an item identified in the trigger.

In operation 710, the retail optimization unit transmits the associated advertisement and/or advertisement materials to an advertising apparatus.

In operation 711, the advertising apparatus displays advertising materials.

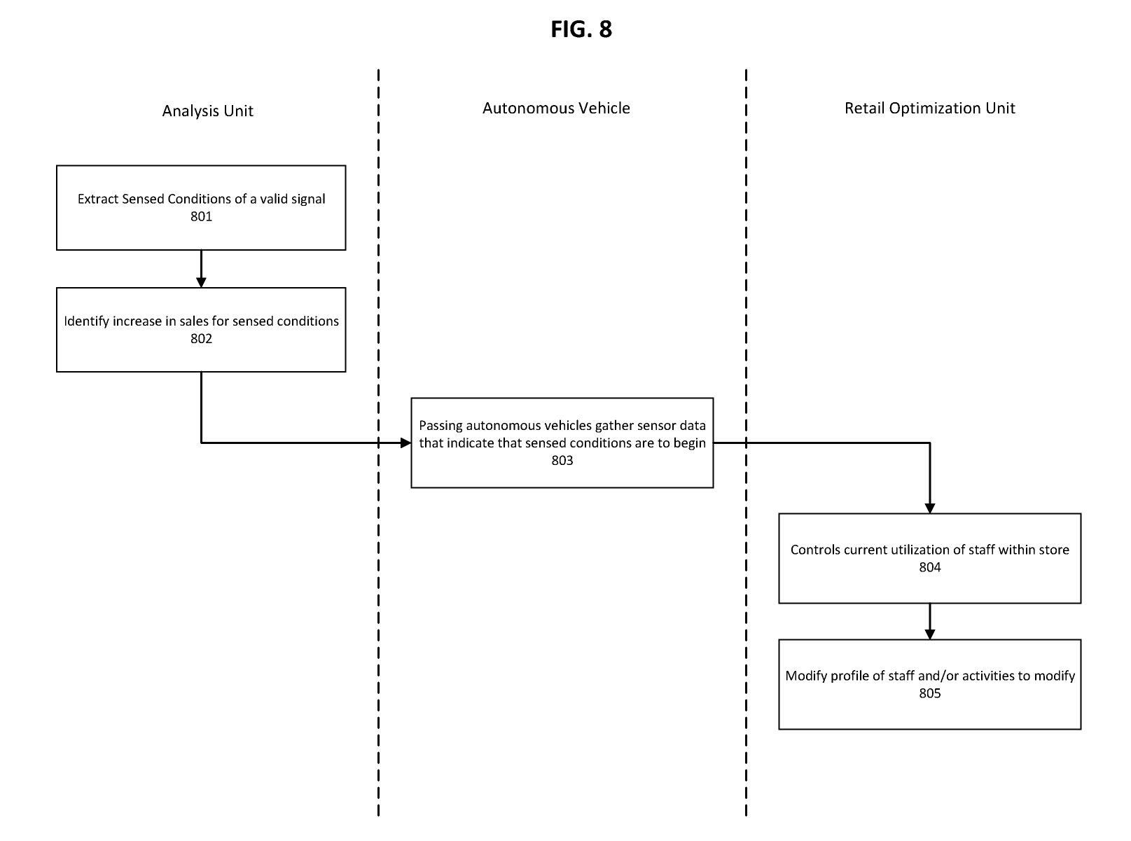

FIG. 8 shows an exemplary optimization process for a retailer, according to an aspect of the present disclosure.

In operation 801, an analysis unit extracts one or more sensed conditions of a valid signal, which may be stored in a signal database of the analysis unit. A valid signal may include identification of a set of sensor data, or sensed conditions. For example, co-occurrence of a certain profile of a customer passing the retailer facility in a certain direction when the weather has certain characteristics.

In operation 802, identify an increase in sales for the sensed conditions.

In operation 803, passing autonomous vehicles gather sensor data that indicate that sensed are to begin.

In operation 804, the retail optimization unit controls current utilization of staff within the retailer. For example, the utilization of staff may specify which staff members are operating the registers, maintaining display areas of the retailer, are on break and the like.

In operation 805, the retail optimization unit modifies a profile of staff and/or activities to best match forthcoming increase in sales. For example, organization of a display area within the retailer. Such process may combine a dynamic re-assignment of tasks for the employees. In an example, if a sharp increase in sales activities is expected, then more staff members may be assigned to man the registers. Also, display of merchandize may be modified. For example, specific display arrangement or placement of items.

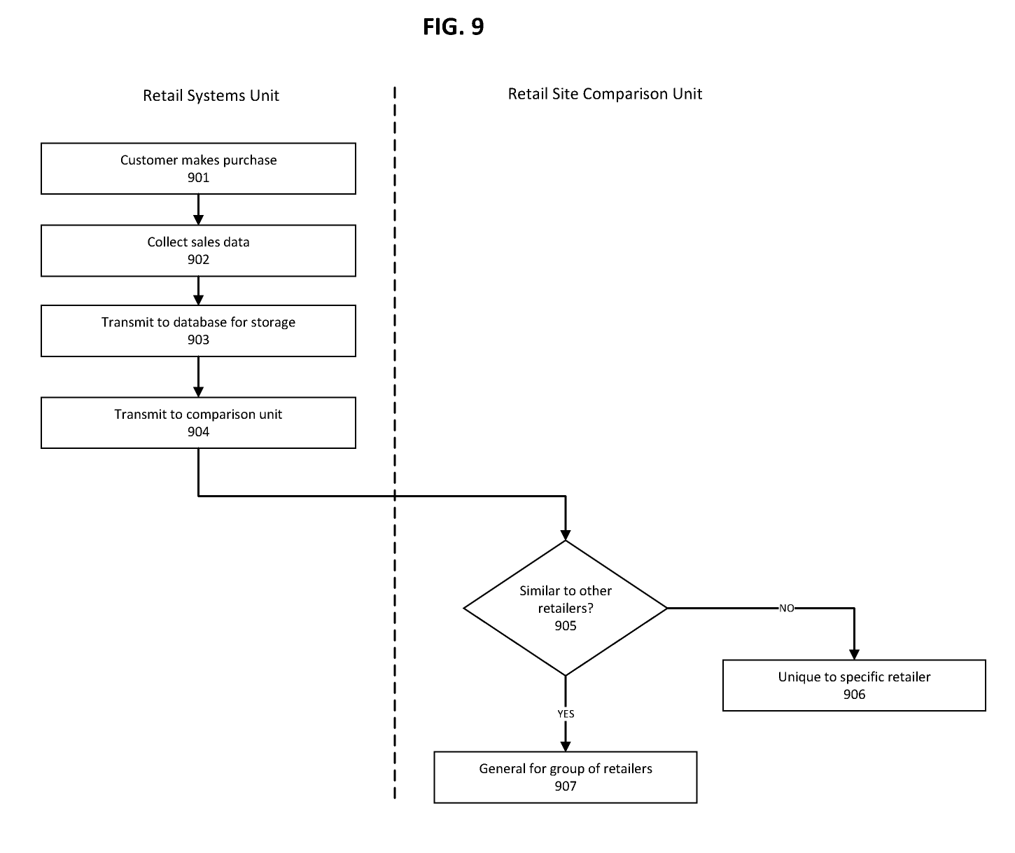

FIG. 9 shows an exemplary process for comparing of data of multiple retailers, according to an aspect of the present disclosure.

In operation 901, a customer purchases one or more items at a retailer. The items may be include goods or services that may be purchased via payment. The items may be purchased at registers, near field communication (NFC) terminals, credit card payment terminals, and smartphone enable payment.

In operation 902, once the payment transaction has been completed, sales data related to the sales transaction is collected. The sales data may include, without limitation, sold items (e.g., description of item sold, price, applicable sales promotion, applicable coupons, and the like), time and/or day at which the items were sold, location or department at which the items were sold.

In operation 903, the generated sales data is transmitted to the sales database for storage. In an example, the sales data may be stored for a predetermined period of time before being purged.

In operation 904, the retail systems unit transmits the sales data to a comparison unit.

In operation 905, the comparison unit determines whether sales data from one retailer is similar to sales data from other retailer(s). In an example, such comparisons for determination may be performed over and over for determining correlation between the sensor data and the sales data.

If the sales data are similar between multiple retailers, the sales data may be combined or grouped to provide for a larger or more reliable dataset in operation 907. For example, data that may be relevant across a retailer may be set that sales of sport drinks of brand X increases when the temperature is between 18 degrees Celsius and 22 degrees Celsius.

If the sales data of a one retailer is determined to be unique for the one retailer, the sales data may be maintained separately from sales data of other retailers in operation 906.

According to aspects of the present application, autonomous vehicles may be utilized to collect various sensor data to identify various sensor data correlated to sales activity at a retailer using existing sensors (which may be used to perform their primary operations of identifying a location of the vehicle and surrounding environment and guiding the vehicle). Further, the autonomous vehicles may be rerouted to a specified path or paths for collection of additional sensor data related to sales activities. The autonomous vehicles may also have other controls altered, such as speed, for collection of certain sensor data. The autonomous vehicles may be used independently or in collaboration with other autonomous vehicles to gather sensor data.

By using the autonomous vehicles, relevant sensor data may be collected over a larger area outside of a retailer facility. For example, it may be advantageous to gather data of people walking towards the retailer facility from 500 meters away, or people congregating at certain areas near the retailer facility (e.g., a bus stop).

Further, the sensor data may be analyzed with respect to nearby retailers to determine correlation between the sensor data and sales data gathered by the retailers. Based on the determined correlations, various processes of the retailers (e.g., advertising of products, store layout, staffing, and the like) may be modified to better accommodate expected changes in sales activities based on the sensor data collected by the autonomous vehicles.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

As described above, according to an aspect of the present disclosure, a method is provided for optimizing sales activity at a retailer. The method includes receiving, from a first server, sales data; receiving, from a second server, sensor data collected by an autonomous vehicle; identifying, by a processor, an instance where a portion of the sensor data and a portion of the sales data are correlated; identifying, by the processor, the portion of the sensor data included in the instance where the portion of the sensor data and the portion of the sales data are correlated as a trigger signal; and modifying, by the processor, a process of a target retailer based on the trigger signal.

According to another aspect of the present disclosure, the sales data includes a description of items sold, a time at which the items were sold, and a location at which the items were sold.

According to yet another aspect of the present disclosure, the sales data is collected from one or more payment transaction terminals located within a retailer facility.

According to still another aspect of the present disclosure, further includes comparing, by the processor, the trigger signal with a predetermined threshold; if strength of the trigger signal is greater than or equal to the predetermined threshold, determining the trigger signal to be a valid trigger signal; and if the strength of the trigger signal is less than the predetermined threshold, determining the trigger signal to be an intermediate trigger signal.

According to another aspect of the present disclosure, further includes generating, by the processor, a route modification request for collecting supplemental sensor data, in which the supplemental sensor data increases the strength of the trigger signal for validating the trigger signal.

According to yet another aspect of the present disclosure the route modification request specifies a speed of travel for the autonomous vehicle during collection of supplemental sensor data.

According to still another aspect of the present disclosure, the route modification request specifies the supplemental sensor data to be collected.

According to still another aspect of the present disclosure, the autonomous vehicle collects the sensor data within a reference distance from the target retailer for identifying the trigger signal.

According to yet another aspect of the present disclosure, further includes collecting, by a retail system in each of the plurality of retailers, corresponding sales data; comparing, by the first server, sales data of two or more of the plurality of retailers for similarity; determining, by the first server, existence of sufficient similarity of the compared sales data if an amount of similarity is greater than or equal to a reference threshold; aggregating, by the first server, the sales data having the sufficient similarity; and transmitting, by the first server, the aggregated sales data as the sales data received from the first server.

According to still another aspect of the present disclosure, further includes collecting, by a retail system in each of the plurality of retailers, corresponding sales data; comparing sales data of two or more of the plurality of retailers for similarity; determining existence of insufficient similarity of the compared sales data if an amount of similarity is less than a reference threshold; identifying sales data of a local retailer among the plurality of retailers as local sales data when the sales data of the local retailer has the insufficient similarity with sales data of other retailers of the plurality of retailers; and transmitting the local sales data as the sales data received from the first server.

According to another aspect of the present disclosure, the modifying of the process of the target retailer includes a modification of organization of a display area of the target retailer.

According to yet another aspect of the present disclosure, the modifying of the process of the target retailer includes a modification of inventory management.

According to still another aspect of the present disclosure, the modifying of the process of the target retailer includes dynamic generation of a promotion.

According to still another aspect of the present disclosure, the method further includes identifying an advertisement corresponding to the trigger signal.

According to still another aspect of the present disclosure, the method further includes transmitting the advertisement to an advertising apparatus, in which the advertising apparatus includes a display and a speaker.

According to still another aspect of the present disclosure, the advertising apparatus is equipped on the autonomous vehicle.

According to still another aspect of the present disclosure, the autonomous vehicle includes at least one of: an image sensor, an audio sensor, a motion sensor, a light sensor, a radio sensor, a radio sensor, and a meteorological sensor.

According to still another aspect of the present disclosure, the method further includes collecting another set of sensor data collected by another autonomous vehicle; and determining, by the other vehicle and based on the other set of sensor data, that an increase in sales activity is expected when the other set of sensor data corresponds with the trigger signal.

According to another aspect of the present disclosure, a non-transitory computer readable storage medium that stores a computer program, the computer program, when executed by a processor, causing a computer apparatus to perform a process is disclosed. The process includes receiving, from a first server, sales data; receiving, from a second server, sensor data collected by an autonomous vehicle; identifying an instance where a portion of the sensor data and a portion of the sales data are correlated; identifying the portion of the sensor data included in the instance where the portion of the sensor data and the portion of the sales data are correlated as a trigger signal; and modifying a process of a target retailer based on the trigger signal.

According to yet another aspect of the present disclosure, a computer apparatus for updating map data for an autonomous vehicle (AV) is provided. The computer apparatus includes a memory that stores instructions, and a processor that executes the instructions, in which, when executed by the processor, the instructions cause the processor to perform a set of operations. The set of operations includes receiving, from a first server, sales data; receiving, from a second server, sensor data collected by an autonomous vehicle; identifying an instance where a portion of the sensor data and a portion of the sales data are correlated; identifying the portion of the sensor data included in the instance where the portion of the sensor data and the portion of the sales data are correlated as a trigger signal; and modifying a process of a target retailer based on the trigger signal.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for optimizing operations using an autonomous vehicle, the method comprising:
receiving, from a first server, input data;
receiving, from a second server, sensor data collected by the autonomous vehicle;
identifying, by a processor, an instance where a portion of the sensor data and a portion of the input data are correlated;
identifying, by the processor, the portion of the sensor data included in the instance where the portion of the sensor data and the portion of the input data are correlated as a trigger signal; and
modifying, by the processor, a process of a target retailer based on the trigger signal.

2. The method of claim 1, wherein the input data includes
a description of items sold,
a time at which the items were sold, and
a location at which the items were sold.

3. The method of claim 1, wherein the input data includes sales data collected from one or more payment transaction terminals located within a retailer facility.

4. The method of claim 1, further comprising:
comparing, by the processor, the trigger signal with a predetermined threshold;
if strength of the trigger signal is greater than or equal to the predetermined threshold, determining the trigger signal to be a valid trigger signal; and
if the strength of the trigger signal is less than the predetermined threshold, determining the trigger signal to be an intermediate trigger signal.

5. The method of claim 4, further comprising:
generating, by the processor, a route modification request for collecting supplemental sensor data,
wherein the supplemental sensor data increases the strength of the trigger signal for validating the trigger signal.

6. The method of claim 5, wherein the route modification request specifies a speed of travel for the autonomous vehicle during collection of supplemental sensor data.

7. The method of claim 5, wherein the route modification request specifies the supplemental sensor data to be collected.

8. The method of claim 1, wherein the autonomous vehicle collects the sensor data within a reference distance from the target retailer for identifying the trigger signal.

9. The method of claim 1, further comprising:
collecting, by a retail system in each of the plurality of retailers, corresponding input data;
comparing, by the first server, input data of two or more of the plurality of retailers for similarity;
determining, by the first server, existence of sufficient similarity of the compared input data if an amount of similarity is greater than or equal to a reference threshold;
aggregating, by the first server, the input data having the sufficient similarity; and
transmitting, by the first server, the aggregated input data as the input data received from the first server.

10. The method of claim 1, further comprising
collecting, by a retail system in each of the plurality of retailers, corresponding input data;
comparing input data of two or more of the plurality of retailers for similarity;
determining existence of insufficient similarity of the compared input data if an amount of similarity is less than a reference threshold;
identifying input data of a local retailer among the plurality of retailers as local input data when the input data of the local retailer has the insufficient similarity with input data of other retailers of the plurality of retailers; and
transmitting the local input data as the input data received from the first server.

11. The method of claim 1, wherein the modifying of the process of the target retailer includes a modification of organization of a display area of the target retailer.

12. The method of claim 1, wherein the modifying of the process of the target retailer includes a modification of inventory management.

13. The method of claim 1, wherein the modifying of the process of the target retailer includes dynamic generation of a promotion.

14. The method of claim 1, further comprising:
identifying an advertisement corresponding to the trigger signal.

15. The method of claim 14, further comprising:
transmitting the advertisement to an advertising apparatus,
wherein the advertising apparatus includes a display and a speaker.

16. The method of claim 15, wherein the advertising apparatus is equipped on the autonomous vehicle.

17. The method of claim 1, wherein the autonomous vehicle includes at least one of:
an image sensor,
an audio sensor,
a motion sensor,
a light sensor,
a radio sensor,
a radio sensor, and
a meteorological sensor.

18. The method of claim 1, further comprising
collecting another set of sensor data collected by another autonomous vehicle; and
determining, by the other vehicle and based on the other set of sensor data, that an increase in sales activity is expected when the other set of sensor data corresponds with the trigger signal.

19. A non-transitory computer readable storage medium that stores a computer program, the computer program, when executed by a processor, causing a computer apparatus to perform a process comprising:
receiving, from a first server, input data;
receiving, from a second server, sensor data collected by an autonomous vehicle;
identifying an instance where a portion of the sensor data and a portion of the input data are correlated;
identifying the portion of the sensor data included in the instance where the portion of the sensor data and the portion of the input data are correlated as a trigger signal; and
modifying a process of a target retailer based on the trigger signal.

20. A computer apparatus for optimizing operations using an autonomous vehicle, the computer apparatus comprising:
a memory that stores instructions, and
a processor that executes the instructions,
wherein, when executed by the processor, the instructions cause the processor to perform operations comprising:
receiving, from a first server, input data;
receiving, from a second server, sensor data collected by the autonomous vehicle;
identifying an instance where a portion of the sensor data and a portion of the input data are correlated;
identifying the portion of the sensor data included in the instance where the portion of the sensor data and the portion of the input data are correlated as a trigger signal; and
modifying a process of a target retailer based on the trigger signal.
